(19) United States
(12) Patent Application Publication
(10) Pub. No.: US 2025/0275022 A1
(43) Pub. Date: Aug. 28, 2025

(54) AN INDUCTION HEATER

(71) Applicant: Cryolec Limited, Newcastle Upon Tyne (GB)

(72) Inventor: Andrew BURREL, Newcastle Upon Tyne (GB)

(21) Appl. No.: 18/858,226

(22) PCT Filed: Apr. 21, 2023
(86) PCT No.: PCT/GB2023/051044

§ 371 Date: Oct. 18, 2024

(30) Foreign Application Priority Data
Apr. 21, 2022 (GB) 2205797.0

(51) Int. Cl. H05B 6/10; F16L 59/065

(52) U.S. Cl. CPC H05B 6/108; F16L 59/065

(57) ABSTRACT

An electrical induction heater for heating a cryogenic liquid or gas is disclosed. The heater comprises a heater body, defining a plurality of fluid channels. Each channel is open at each end with at least one of said channels having a fluid inlet and at least a second channel having a fluid outlet. The heater body is formed of an electrically conducting material. An electric coil to receive an a/c current is present, the electric coil being wound about the heater body. One or more connector channels fluidly connect, pairwise, the open ends of the fluid channels such that the channels and the connectors form a fluid path between the fluid inlet and the fluid outlet.

### FIELD OF THE INVENTION

The present invention relates to an apparatus to generate a hot or superheated gas. The invention further relates to an apparatus to directly vaporise and heat a cryogenic fluid initially in the liquid state. The gas particularly contemplated and exemplified herein is nitrogen gas, which in a particularly contemplated aspect of the invention is for use in the oil and gas production industry. However, the apparatus is also suitable for use with other target materials such as Natural Gas and/or Liquified Natural Gas (LNG), Argon/liquid argon, oxygen/liquid oxygen.

### BACKGROUND TO THE INVENTION

Nitrogen is a relatively unreactive element and is used widely in the oil and gas industries as it is readily available—including being able to be produced in some circumstances on-site—and can be provided in both liquid and gas states. Because of its unreactive nature, nitrogen does not usually engage chemically with any oil or gas with which it comes into contact. The liquid form is convenient when supplying from off-site or for storage as the volume occupied by a particular mass of nitrogen is far smaller as a liquid than as a gas.

Nitrogen gas can be used to, for example, aid in recovery or sustaining production in a relatively old well where reserves are depleted or to increase production. Further, the gas can also be used to purge unwanted chemicals from a volume or region to reduce the build up of hazardous materials, such as VOCs which might cause an explosion risk. Further, pipelines can be dried using nitrogen gas, particularly heated gas, where for example a pipeline has been newly installed or cleaned with water. Nitrogen is also commonly used for high pressure leak testing in combination with helium as a trace gas.

Where the nitrogen is supplied initially in liquid form, the nitrogen first needs to be converted into a gas in a controlled and safe fashion. Usually also the temperature needs to be raised as the boiling point of liquid nitrogen at atmospheric pressure is around −196° C. Moreover, many uses call for the nitrogen to be raised to an elevated temperature of 200° C.-350° C. There is a need therefore for a means of rapidly heating high volumes of nitrogen gas to a higher temperature. Although the latent heat and the heat capacity of nitrogen gas are both relatively low, this still requires a lot of energy and moreover, the means to heat the nitrogen would advantageously occupy only a relatively small volume as space available may be at a premium.

Apparatus is known which can carry out vaporisation and heating. However the devices known are inefficient and are powered primarily by heat recovered from a diesel engine, which is inefficient, relatively large in size and also often difficult to operate in confined spaces and especially in environments where there is a fire risk due to organic chemicals in the surroundings. Devices that use electrical power only are also known and include water bath heat exchangers. Both heating via a diesel engine or through a water bath heat exchanger require an intermediate process medium, such as water, to heat the target material (e.g. the nitrogen). The intermediate process medium is heated by exchange of heat with the diesel engine or electrical element in the water bath. Heat is transferred into the nitrogen from this intermediate process medium. This is less efficient than direct heating, which is the nature of the present invention.

It is an object of the present invention to provide an apparatus which can rapidly heat a volume of nitrogen or other target material to high temperatures and a further object to provide an apparatus to vaporise nitrogen from the liquid to the gaseous state.

### SUMMARY OF THE INVENTION

According to a first aspect of the invention there is provided an electrical induction heater for heating a cryogenic liquid or gas, the heater comprising;
a heater body, defining a plurality of fluid channels, open at each end, at least one of said channels having a fluid inlet and at least a second channel having a fluid outlet;
the heater body formed of an electrically conducting material;
an electric coil to receive an a/c current, the electric coil being wound about the heater body;
one or more connector channels to fluidly connect, pairwise, open ends of the fluid channels such that the channels and the connectors form a fluid path between the fluid inlet and the fluid outlet.

Preferably, the fluid channels are cylindrical to improve the flow of eddy currents in the body.

Preferably, each channel houses a tubular insert pipe of complementary shape to the channel, which is further preferably retained in position by a slide-fit mechanism.

Preferably, the heater body includes a centrally deployed hollow region, which further preferably contains a vacuum or alternatively an electrically insulating material.

The heater body is optionally in the shape of a right-cylinder. Alternatively optionally, the shape of the heater body is a rectangular cuboid, which further optionally has rounded corners to avoid heat build up at said corners.

Optionally the heater body is formed of a medium carbon steel.

Preferably, the or each connector channel is a connector tube, further preferably in the form of a U-bend and yet further preferably formed of two sections, each of 90°. Alternatively, the connector channel comprises a bottom-drilled cap defining a plurality of connector channels pairwise linking the ends of insert pipes to fluidly connect pairs of fluid channels.

### BRIEF DESCRIPTION OF THE DRAWINGS

The invention is now described with reference to the accompanying drawings which show, by way of example only, one embodiment of a vaporiser or superheater. In the drawings:

FIGS. 1a-1d are perspective views of four embodiments of vaporiser or superheater;

FIGS. 2a-2c are a back, side and front view of the superheater of FIG. 1a;

FIGS. 3a-3c are a front, side and back view of the vaporiser of FIG. 1b;

FIGS. 4a, 4b are top and side views respectively of a block included in the superheater of FIG. 2;

FIGS. 5a, 5b are top and side views respectively of a block included in the vaporiser of FIG. 3;

FIGS. 6a-6e are respectively a perspective view of the block in the vaporiser/superheater of FIG. 1d, a view of the top cap, the top-drilled cap, the bottom-drilled cap, and the bottom-milled cap in FIG. 6a.

FIGS. 7a-7c are respectively a perspective view, a side view and an end view of a fifth embodiment of a block.

### DETAILED DESCRIPTION OF THE INVENTION

Reference in this application is to an apparatus for treating nitrogen to vaporise or to heat the nitrogen. It will be understood that the apparatus is also suitable for use in treating other fluids known in the art.

The use of nitrogen in industry, for example in the oil and gas industry is widespread due to its being relatively inert chemically and its ease of liquefaction/vaporisation. In order to more easily transport and store, the nitrogen is usually supplied as a pressurised liquid. There is therefore a requirement to vaporise and/or heat the nitrogen up to the use temperature. In many sites, the nitrogen is produced at a certain, lower temperature, of the order of 0° C.-40° C., and there is then the requirement to heat a portion of that nitrogen to a much higher temperature, of the order of 200° C.-350° C. The lower temperature nitrogen is useful for purging piping/vessels/equipment to provide an inert environment. It can also be used for pressuring piping/vessels/equipment for the purposed of pressure testing or leak testing. The higher temperature nitrogen is particularly useful in the cleaning and/or removal of specific chemical and deposits, such as hydrocarbons, within refinery and/or industrial environments and also for rapid drying. The nitrogen can also regenerate certain catalysts.

The heating is often accomplished using heat immediately derived from the burning of a fossil fuel, such as via a diesel motor. This brings with it environmental and also hazard considerations. Additionally, a motor of the energy output capability needed to heat large volumes of nitrogen needs to be quite large which is not always feasible to install in many oil and gas extraction sites due to the lack of space. There is a need therefore to provide a heating means of smaller size and having a lesser environmental impact.

The heater described below utilises induced flow of an electric current to provide the heating. The hereindescribed heaters are suitable to provide typically, for example, 4-7 tonnes/hour of nitrogen at a temperature of from 150-350° C. However, the size of a heater produced can be scaled up to produce larger quantities when so required.

Heating for the heaters is provided via electric induction. An electric coil (not illustrated) is wound around a conducting, typically metal, body. When an alternating electric current passes through the coil, the magnetic field thereby produced induces currents, referred to as eddy currents, within the metal of the body. The currents encounter Ohmic resistance which converts energy from the eddy currents into thermal energy which heats the body. The thermal energy thus generated is transferred through the body and any pipe walls to the fluid flowing within the pipes of the heater as the fluid passes through. Additionally, heating can be generated by a further mechanism in magnetic materials. The alternating current in the coil creates a magnetic field that is constantly changing. As the magnetic field changes direction, the magnetic dipoles of the workpiece change polarity. The oscillation of the dipoles causes energy losses in the form of heat, called hysteresis losses, which heat is transferred to the target material.

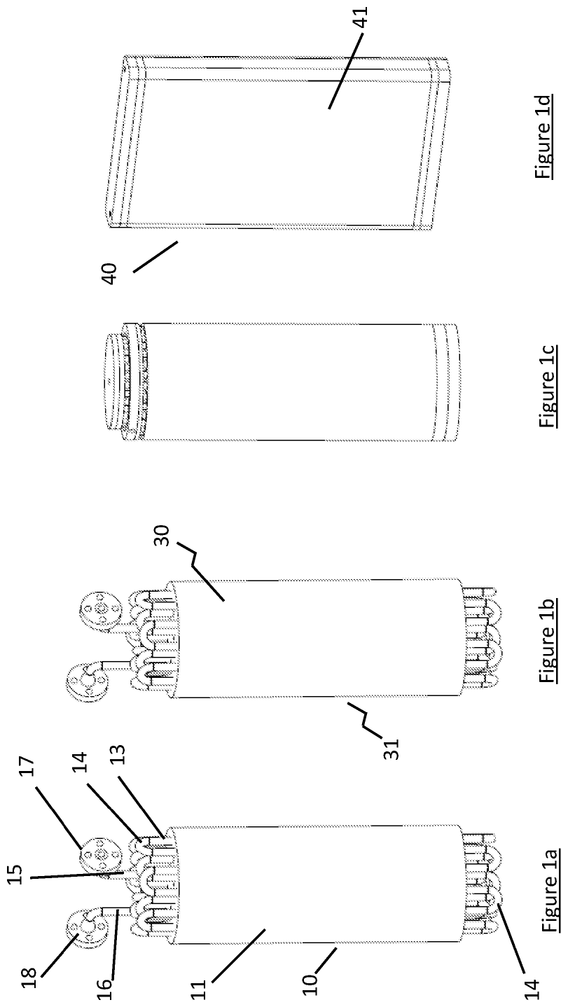

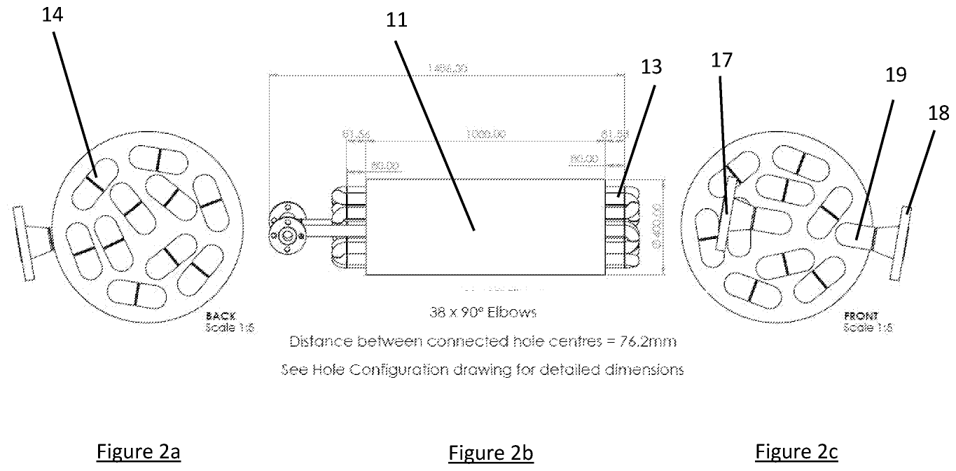

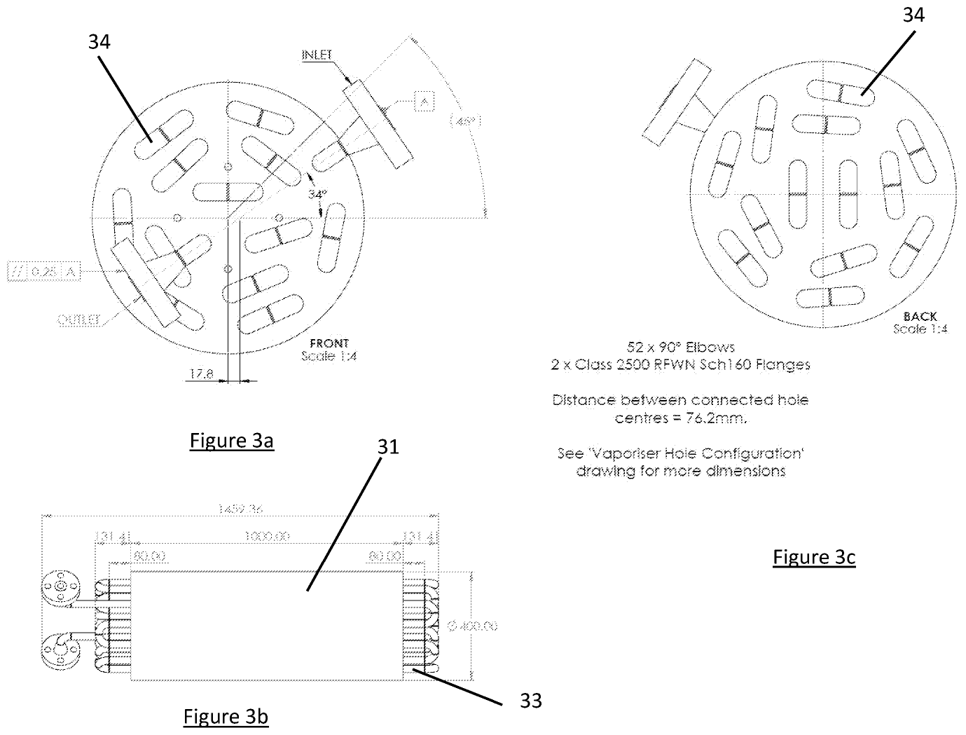

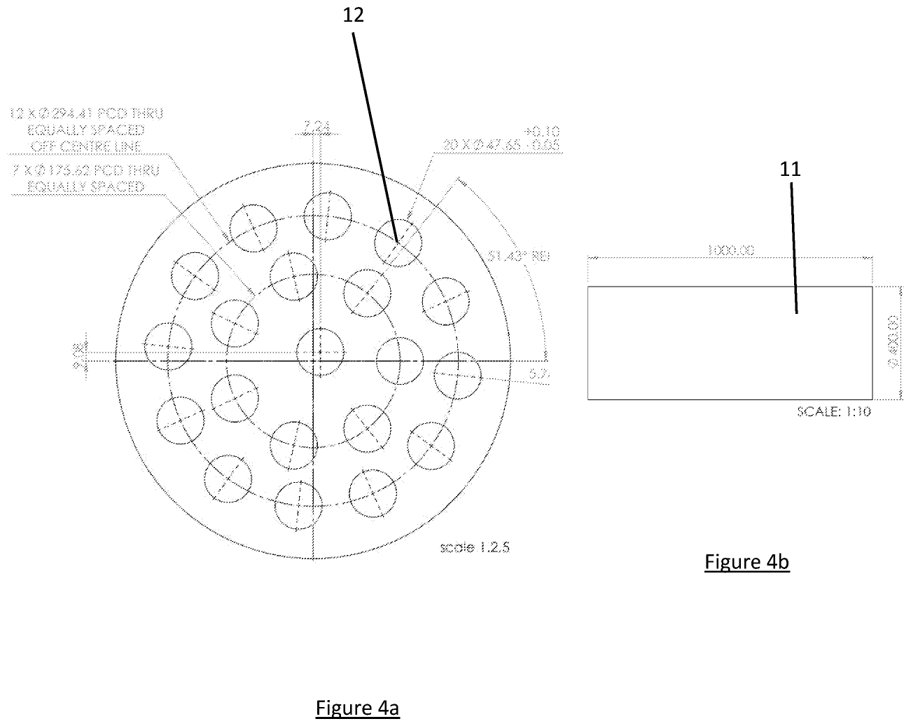

Referring initially to FIGS. 1a and 1b, these illustrate a heater based on a cylindrical block or billet of steel. The steel chosen for the heater is selected to suit the intended purpose. The blocks are preferably designed in such a way that the billet will never be in contact with liquid nitrogen. Therefore, a billet can be manufactured from appropriate materials such as medium carbon steels, e.g., EN8 or C45. The main metric for billet material choice is electrical resistivity—high resistivity leads to faster heating. Magnetic permeability is also important in this application due to its effect on induction efficiency.

The heater in FIG. 1a, generally referenced 10, is suitable for producing 4 tonnes per hour of nitrogen at a temperature of 250° C. from an initial temperature of 150° C. by means of a 300 kW heating source. The heater 10 has a cylindrical body 11 having a diameter of 400 mm and a length of 1000 mm and formed from a normalised C45 medium carbon steel. Running the length of the cylindrical body 11, and parallel to the main axis thereof, is a plurality of cylindrical channels 12 (see FIG. 4a): 20 in number. The cylindrical channels 12 can be drilled from an initially solid cylinder and are approximately 1½″ (3.8 cm) in diameter. The channels 12 accommodate cylindrical pipes 13 of 1½″ (3.8 cm) diameter formed of Nominal Pipe Size (NPS) Schedule 40S stainless steel, and held within the cylindrical channels 12 by a slide fit to better accommodate expansion and contraction. In total the length of pipe within the exemplified embodiment is typically around 20 m. Where the billet is formed of a material able to withstand the temperatures of the materials, then the use of pipes can be obviated.

Each of the pipes 13 extends at both ends beyond the end of the cylindrical body 11. Neighbouring cylindrical pipes are fluidly joined together by U-bends 14 which bridge across the ends of the neighbouring pipes. The U-bends 14 can be formed of a single piece of metal or of two separate half-pieces joined together. It will be noted that the U-bend 14 at one end of a cylindrical pipe 13 joins the particular cylindrical pipe 13 to a different cylindrical pipe 13 than does the U-bend 14 at the second end of the cylindrical pipe 13. In this way the cylindrical pipes 13 are joined together to form a continuous fluid channel linking the inlet to the outlet. In addition, the U-bends 14 act to induce turbulence into the fluid flow within the channel, breaking up any laminar flow and causing a more even heat distribution within the fluid.

At the end of each of a central outlet pipe 15 and an outer inlet pipe 16 is a 1½″ class 300 weld neck flange 17, 18 joined to the particular pipe 15, 16 by a half-piece connector 19. The outlet flange 17 and the inlet flange 18 are coupled in-use to a source of nitrogen and to the target of the heated nitrogen respectively.

Example 1: utilising the heater 10, a series of tests were carried out in which the inlet temperature of the nitrogen ranged from 5° C. to 52° C. Temperature was measured using K-type thermocouples at the inlet and the outlet of the heater 10. The flow rate of nitrogen through the heater 10 was from 500 m³/hour to 3500 m³/hour (\tilde{ }600 kg/hour to \tilde{ }4000 kg/hour). An average temperature rise of the nitrogen during the heating of 168.5° C. was observed, with a maximum temperature rise of 283.9° C. for a flow rate of 1000 m³/hour (\tilde{ }1200 kg/hour).

Example 2: utilising nitrogen at 153° C. at the inlet, an outlet temperature for the fluid of 325° C. was observed. The outlet temperature was steady over a period of 20 minutes with a flow rate of 1630 m³/hour (\tilde{ }2000 kg/hour).

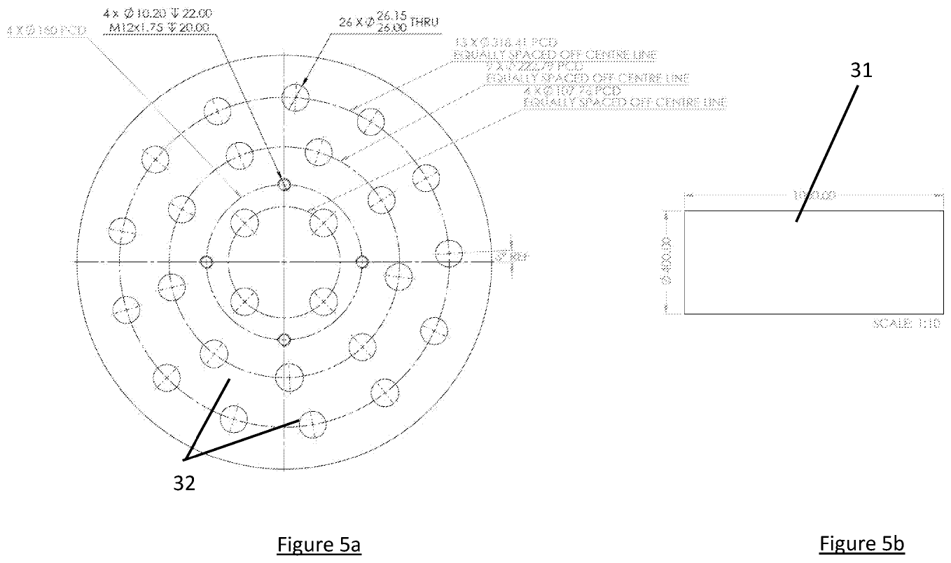

Referring now to FIGS. 1b and 5, these illustrate a vaporiser for converting liquid nitrogen to gaseous nitrogen. The design of the heater, generally referenced 30, and having a cylindrical body 31, is substantially as that of the heater 10 of FIG. 1a. The cylindrical body 31 can be formed of a medium carbon steel such as EN8 or C45. A plurality of cylindrical channels 32 run parallel to the main axis of the cylindrical body 31. The channels 32 are of ¾″ (1.9 cm) diameter compared to the 1½″ (3.8 cm) of the channels 12. This allows a greater number of channels 32 to be present within the body 31 and increases the combined surface area of the channels 32 compared to the heater of FIG. 1a. Heat transfer is therefore increased compared to the first embodiment of FIG. 1a, which heat transfer is believed to be required to achieve the phase change from liquid to gas, which requires more heat energy per mole of nitrogen compared with simply raising the temperature of gaseous nitrogen by a degree.

The channels 32 accommodate cylindrical pipes 33 of ¾″ (1.9 cm) diameter formed of schedule 160S stainless steel to withstand a high flow pressure, and held within the cylindrical channels 32 by a slide fit to better accommodate expansion and contraction. The ends of the pipes 33 extend from the cylindrical body 31 and are joined together, in pairs by U-bends 34 to direct fluid flow from one pipe into the connected pipe and back into the cylindrical body 31 for further heat transfer to take place. The U-bend 34 is preferably formed of two 90° sections welded together to form a 180° bend.

In an alternative embodiment, not illustrated, the body has the form of a hollow cylinder in which a small cylinder whose axis is aligned with and along the main cylinder body axis, has been removed, essentially forming a cylindrical tubular body. This reduces the thickness of the body and allows more heat to be available within the body and so to be received by the pipes. In an additional alternative embodiment, the volume removed is replaced by a heat-insulating material to reduce heat losses into the space. Efficiency is thereby increased. In a further alternative embodiment, there is a vacuum in the internal volume of the hollow cylinder which again reduces heat loss into the volume. Using a hollow cylindrical body also allows a higher number of channels to be provided as the fluid links between pipes can be manifolded which enables the pipes to be closer together and provides the nitrogen to follow multiple paths through the body.

The embodiment of FIG. 1c shows a heater 36 having a right-cylindrical body 37. The heater 36 has a milled cap manifold on the outer set of pipes, which works as an inlet, and has a manifold on the inner set of pipes which acts as an outlet. This gives a single inlet and outlet, and 60 paths for nitrogen to take through the block.

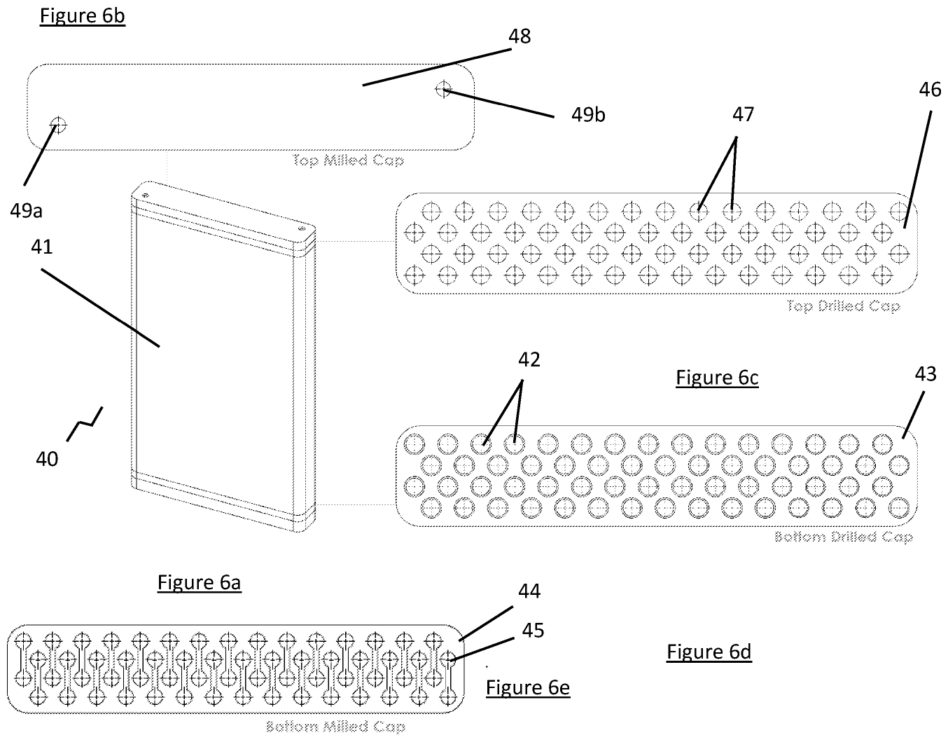

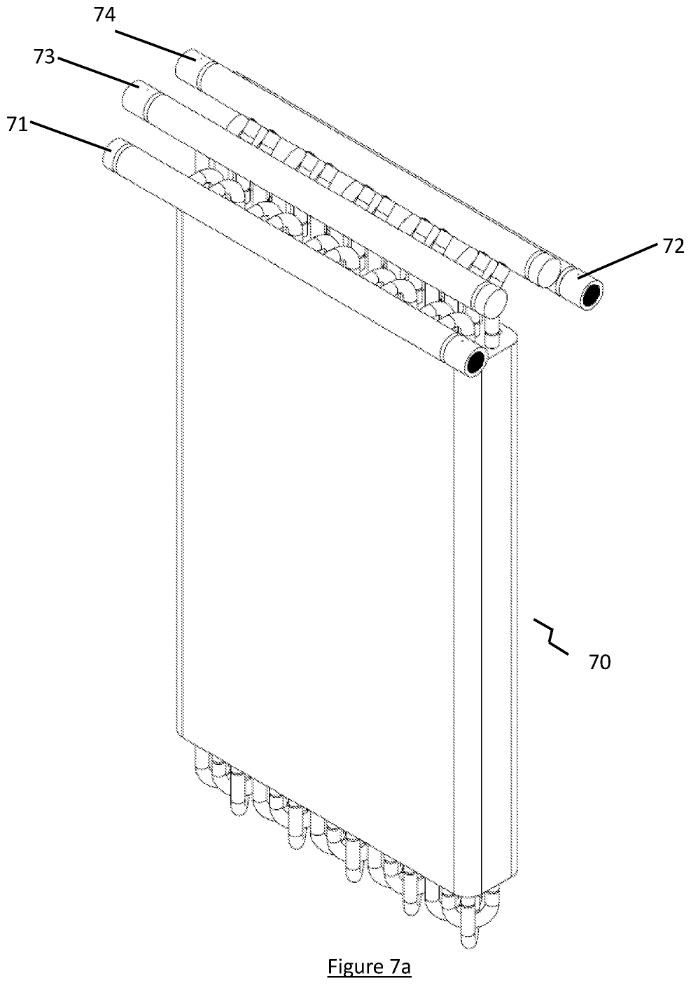

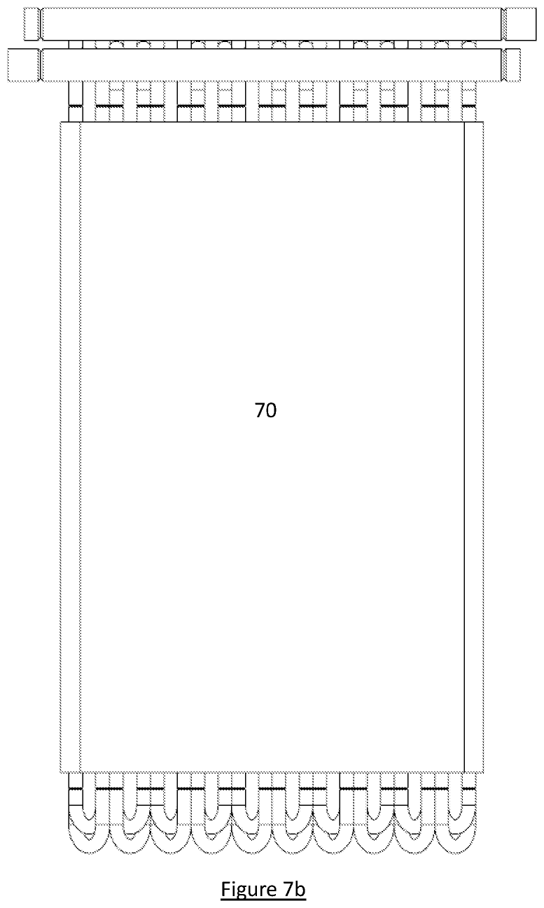

Referring to FIG. 1d and FIG. 6, these illustrate a heater 40 having a rectangular cuboid body 41. The thickness of the body 41, similar to that described above in respect of the heater having a hollow cylindrical body, is less than for the first embodiment, which increases the efficiency of heat transfer to all parts of the body. The corners of the body 41 are rounded to a large radius to avoid heat build up which the use of eddy currents would cause to occur at corners. The use of the rectangular cross-section for the body 41 as shown in FIG. 6 also allows for a greater number of channels to be provided through the body 41. This is further facilitated by using a bottom drilled-cap 43 in conjunction with the milled cap 44 as shown in FIG. 6e to provide links between the ends of pipes: thereby removing the restriction on the radius of the connection which is a limiting factor for the design of FIG. 1a.

The bottom-drilled cap 43 has drilled therethrough holes 42, which are placed so that the holes 42 are located over the ends of the channel through the body 41. The bottom-drilled cap 43 prevents liquid nitrogen from coming into contact with the carbon steel block and causing embrittlement. The bottom-milled cap 44 has milled paths 45 within the body of the material from which it is formed to direct fluid from the end of one channel to the entrance to another channel. This allows a tighter bend to be achieved and for a higher density of channels to be provided within the body 41. The bottom-milled cap 44 is also provided with an inlet and an outlet to which flanges can be connected as shown for the first and second embodiments of FIGS. 1a, 1b. The drilled and milled caps are made from stainless steel to allow the caps to come into contact with liquid nitrogen and not become brittle.

A top-drilled cap 46 is located over the top of the body 41, the top drilled-cap 46 having a plurality of holes 47 to sit over the ends of the channels in the body 41. A top-milled cap 48, which acts as a manifold, then is located over the top end of the body 41, sandwiching the top-drilled cap 46 therebetween. The top-milled cap 48 has two apertures 49a, 49b to receive pipes to act as an inlet and an outlet for fluid. In an alternative embodiment, not illustrated, the top-milled cap can be formed similarly to the bottom-drilled cap 43. This would require an equal number, such as 30, inlets and outlets.

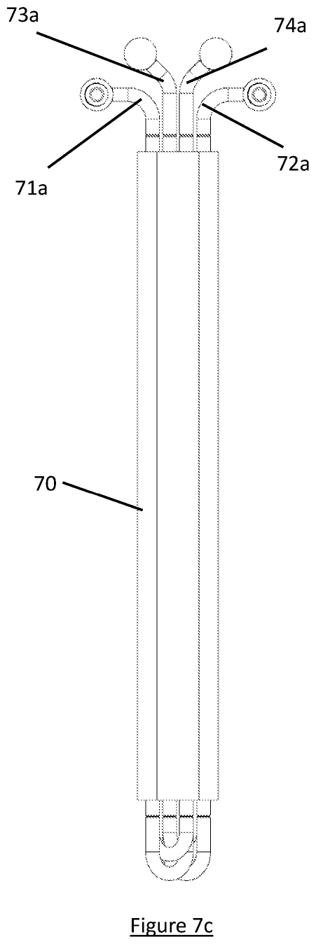

FIGS. 7a-7c illustrate a fifth embodiment of block, generally referenced 70. The block 70 The internal structure of the block 70 is as described above. However, the ends of the pipes retained within the internal channels are fluidly connected to manifolds 71-74 by means of connection pieces 71a-74a. with regard to the inlet manifolds 71, 72 these are located on the outer side of the top of the block 70 to maintain a maximum temperature differential between the cold inlet fluid and the higher temperatures within the block 70. The outlet manifolds 73, 74 are located towards the centre of the top of the block 70. There are two sets of paired inlet and outlet manifolds. The gas going from one manifold to another therefore has a single pass through the block. This slows down the flow and creates a more uniform heat distribution along the block 70. Each of the manifolds 71-74 is formed of thick-walled tube, plugged on one end, and with an autoclave fitting on the other end for easy connection.

Example 3—the block 70 was run for a 24-hour period. During that time, the average outlet temperature was 50° C. at a mass flow rate of 2400 kg/hr

1. An electrical induction heater for heating a cryogenic liquid or gas, the heater comprising;
a heater body, defining a plurality of fluid channels, open at each end, at least one of said channels having a fluid inlet and at least a second channel having a fluid outlet;
the heater body formed of an electrically conducting material;
an electric coil to receive an a/c current, the electric coil being wound about the heater body;
one or more connector channels to fluidly connect, pairwise, open ends of the fluid channels such that the channels and the connectors form a fluid path between the fluid inlet and the fluid outlet,

2. An electrical induction heater according to claim 1, wherein the fluid channels are cylindrical.

3. An electrical induction heater according to claim 1, wherein each channel houses a tubular insert pipe of complementary shape to the channel.

4. An electrical induction heater according to claim 3, wherein a tubular insert is retained in position by a slide-fit mechanism.

5. An electrical induction heater according to any preceding claim 1, wherein the heater body includes a centrally deployed hollow region.

6. An electrical induction heater according to claim 5, wherein the hollow region contains a vacuum.

7. An electrical induction heater according to claim 5, wherein the hollow region contains a an electrically insulating material.

8. An electrical induction heater according to claim 1, wherein the heater body is in the shape of a right-cylinder.

9. An electrical induction heater according to claim 1, wherein the shape of the heater body is a rectangular cuboid.

10. An electrical induction heater according to claim 9, wherein the rectangular cuboid body has rounded corners.

11. An electrical induction heater according to any-preceding claim 1, wherein the heater body is formed of a medium carbon steel.

12. An electrical induction heater according to any-preceding claim 1, wherein the or each connector channel is a connector tube.

13. An electrical induction heater according to claim 12, wherein a connector tube is in the form of a U-bend.

14. An electrical induction heater according to claim 13, wherein a connector tube is formed of two sections, each of 90°.

15. An electrical induction heater according to claim 1, wherein the or each connector channel comprises a bottom-drilled cap defining a plurality of connector channels pairwise linking the ends of insert pipes to fluidly connect pairs of fluid channels.
